(19) United States
(12) Patent Application Publication
(10) Pub. No.: US 2025/0011246 A1
(43) Pub. Date: Jan. 9, 2025

(54) METHOD OF FORMING CERAMIC FLUIDIC MODULES WITH SMOOTH INTERIOR SURFACES AND MODULES PRODUCED

(71) Applicant: CORNING INCORPORATED, CORNING, NY (US)

(72) Inventors: Alexander Lee Cuno, Sayre, PA (US); Thierry Luc Alain Dannoux, Avon (FR); John Walter Grunden, Lawrenceville, PA (US); Yanxia Ann Lu, Sunnyvale, CA (US); James Scott Sutherland, Painted Post, NY (US)

(21) Appl. No.: 18/706,423

(22) PCT Filed: Nov. 2, 2022
(86) PCT No.: PCT/US2022/048671

§ 371 Date: May 1, 2024

Related U.S. Application Data
(60) Provisional application No. 63/275,680, filed on Nov. 4, 2021.

(51) Int. Cl. C04B 38/00; C04B 35/565; C04B 35/622

(52) U.S. Cl. CPC C04B 38/0041; C04B 35/565; C04B 35/62222; C04B 38/0061; C04B 2235/77; C04B 2235/94; C04B 2235/963

(57) ABSTRACT

A fluidic module includes a monolithic closed-porosity ceramic body that has a first region and a second region with the first region disposed between the second region. The first and second regions are configured to differ from one another with respect to a common attribute of a ceramic material of the ceramic body. The common attribute can differ by forming the first and second regions from ceramic particles that differ with respect their particle sizes. The fluidic module further includes a tortuous fluid passage that extends through the ceramic body. The fluid passage is surrounded by the first region such that the fluid passage is separated entirely from the second region at least within a planar region of the ceramic body. The fluid passage has an interior surface with a surface roughness of less than or equal to 5 μm Ra. A method for forming the fluidic module is disclosed.

### CROSS-REFERENCE TO RELATED APPLICATIONS

This application claims the benefit of priority under 35 U.S.C. § 119 of U.S. Provisional Application No. 63/275,680, filed Nov. 4, 2021, the content of which is incorporated herein by reference in its entirety.

### FIELD

The disclosure relates to methods of forming ceramic fluidic modules, and more particularly to methods of forming high density, closed-porosity monolithic silicon carbide fluidic modules with smooth-surfaced tortuous internal passages extending therethrough and to the fluidic modules themselves.

### BACKGROUND

Applicant has developed ceramic powder pressing processes configured to form fluidic modules with complex internal channel structures provided within high density, closed-porosity monolithic ceramic bodies. Such ceramic fluidic modules enable a multitude of continuous flow chemical reactions. The process generally includes surrounding a passage mold formed from a wax or similar heat-meltable material with binder-coated ceramic powder such as ready-to-press (RTP) silicon carbide (SiC) powder. The RTP SiC powder is typically spray dried such that the primary SiC particles are agglomerated together into large granules. These RTP SiC powder granules can be, for example, from 30 μm to 200 μm in diameter with other subranges possible depending the powder supplier. The primary SiC particles prior to coating can have a particle size distribution with a D50 of approximately 0.7 μm.

During the pressing process, the RTP SiC powder is compacted around the passage mold. After pressing, the mold material is removed via a heating process to expose one or more tortuous fluid passages that extend through the pressed (green) ceramic body. The pressed ceramic body is then subjected to debinding and sintering processes to remove the binder and densify and further solidify the pressed body into a monolithic ceramic body. The surface roughness of the internal surfaces of the tortuous fluid passages depend on several factors. It has been found that ultra-smooth internal surfaces are preferred for certain chemical reactions. What is needed, therefore, is a process that reduces the surface roughness of the fluid passages extending through fluidic modules formed from pressed ceramic powder. It would be further advantageous to provide fluidic modules with smooth-surfaced tortuous internal passages formed from such a process.

### SUMMARY

A first aspect of the present disclosure includes a method of forming a ceramic fluidic module for a flow reactor, comprising surrounding a positive passage mold with first ceramic particles, the positive passage mold defining a passage having a tortuous shape, the first ceramic particles having first particle sizes defined by a first particle size distribution (PSD) with a first mean, a first median, and a first mode; positioning the first ceramic particles and the positive passage mold between second ceramic particles, the second ceramic particles having second particle sizes defined by a second PSD with a second mean, a second median, and a second mode, wherein at least one of (i) the first mean is less than the second mean, (ii) the first median is less than the second median, and (iii) the first mode is less than the second mode; pressing the first ceramic particles, the second ceramic particles, and the positive passage mold to form a pressed body; heating the pressed body to remove the positive passage mold; and sintering the pressed body to form a high density, closed-porosity ceramic body having a tortuous fluid passage extending therethrough.

A second aspect of the present disclosure includes a method according to the first aspect, wherein surrounding the positive passage mold with the first ceramic particles comprises: forming a first layer with a first portion of the first ceramic particles, positioning the positive passage mold on the first layer, and forming a second layer on the first layer by covering the first portion of the first ceramic particles and the positive passage mold with a second portion of the first ceramic particles.

A third aspect of the present disclosure includes a method according to the second aspect, wherein positioning the first ceramic particles and the positive passage mold between the second ceramic particles comprises: forming a base layer with a first portion of the second ceramic particles, the first layer of the first ceramic particles formed on the base layer, and forming a cover layer on the second layer by covering the first ceramic particles and the positive passage mold surrounded therein with a second portion of the second ceramic particles.

A fourth aspect of the present disclosure includes a method according to any one of the first through third aspects, further comprising forming an intermediate layer at an interface between the first ceramic particles and the second ceramic particles, the intermediate layer comprising intermediate ceramic particles having intermediate particle sizes defined by an intermediate PSD with an intermediate mean, an intermediate median, and an intermediate mode, wherein at least one of (i) the intermediate mean is between the first and second means, (ii) the intermediate median is between the first and second medians, and (iii) the intermediate mode is between the first and second modes.

A fifth aspect of the present disclosure includes a method according to the fourth aspect, wherein the intermediate ceramic particles increase in size in a direction through the intermediate layer from the first ceramic particles to the second ceramic particles.

A sixth aspect of the present disclosure includes a method according to any one of the first through third aspects, wherein the first ceramic particles have a thickness from about 40% to about 60% of a total thickness of the first and second ceramic particles before pressing.

A seventh aspect of the present disclosure includes a method according to the third aspect, wherein relative to a total thickness of the first and second ceramic particles before pressing, the base layer and the cover layer each have a thickness from about 15% to about 30% of the total thickness and the first layer has a thickness from about 5% to about 20% of the total thickness.

An eighth aspect of the present disclosure includes a method according to the first aspect, wherein surrounding the positive passage mold with the first ceramic particles comprises applying the first ceramic particles to a surface of the positive passage mold to form a surface coating thereon.

A ninth aspect of the present disclosure includes a method according to the eighth aspect, wherein applying the first ceramic particles to the surface of the positive passage mold comprises one or more of washcoating, spraying, and flocking to form the surface coating.

A tenth aspect of the present disclosure includes a method according to the eighth aspect or the ninth aspect, wherein one or more of the first ceramic particles and intermediate ceramic particles are applied in discrete applications such that the surface coating has a plurality of successive layers.

An eleventh aspect of the present disclosure includes a method according to the tenth aspect, further comprising modifying an attribute of a material of each successive layer to form a graded interface between the first ceramic particles and the second ceramic particles.

A twelfth aspect of the present disclosure includes a method according to the eleventh aspect, wherein the attribute includes particle sizes of the intermediate ceramic particles, the particle sizes increasing with each successive layer.

A thirteenth aspect of the present disclosure includes a method according to the eleventh aspect or the twelfth aspect, wherein the attribute includes at least one component of one or more of a ceramic slurry, ceramic slip, solvent, adhesive, and binder associated with the successive layer.

A fourteenth aspect of the present disclosure includes a method according to any one of the first through thirteenth aspects, wherein the first particle sizes are at least about 1 μm and the second particle sizes are at most about 250 μm.

A fifteenth aspect of the present disclosure includes a method according to any one of the first through fourteenth aspects, further comprising processing common ceramic particles to provide the first ceramic particles.

A sixteenth aspect of the present disclosure includes a method according to any one of the first through fifteenth aspects, further comprising processing common ceramic particles to provide the first ceramic particles and the second ceramic particles.

A seventeenth aspect of the present disclosure includes a method according to the fifteenth aspect or the sixteenth aspect, wherein processing the common ceramic particles comprises sieving the common ceramic particles with a sieving mesh having a mesh size, the sieving mesh configured to separate the common ceramic particles into the first ceramic particles and the second ceramic particles.

An eighteenth aspect of the present disclosure includes a method according to the seventeenth aspect, wherein substantially all of the first ceramic particles have first particle sizes that are less than the mesh size and substantially all of the second ceramic particles have second particle sizes that are greater than or equal to the mesh size.

A nineteenth aspect of the present disclosure includes a method according to the seventeenth aspect or the eighteenth aspect, wherein the mesh size is selected to separate a sufficient quantity of the first ceramic particles from the common ceramic particles.

A twentieth aspect of the present disclosure includes a method according to any one of the seventeenth through nineteenth aspects, wherein the common ceramic particles have common particle sizes defined by a common PSD prior to sieving, and wherein the mesh size is a value within a range centered relative to one or more of a mean, a median, and a mode of the common PSD.

A twenty first aspect of the present disclosure includes a method according to any one of the seventeenth through nineteenth aspects, wherein the mesh size is a value in a range of from about 70 μm to about 210 μm.

A twenty second aspect of the present disclosure includes a method according to the fifteenth aspect or the sixteenth aspect, wherein processing the common ceramic particles comprises mixing uncoated ceramic particles with the common ceramic particles to provide the first ceramic particles, the common ceramic particles having common particle sizes defined by a common PSD, the uncoated ceramic particles having uncoated particle sizes configured to reduce one or more of a mean, a median, and a mode of the common PSD via the mixing.

A twenty third aspect of the present disclosure includes a method according to the twenty second aspect, wherein the first ceramic particles comprise: from about 50 wt % to about 85 wt % of the common ceramic particles, and from about 15 wt % to about 50 wt % of the uncoated ceramic particles.

A twenty fourth aspect of the present disclosure includes a method according to the twenty second aspect or the twenty third aspect, wherein the uncoated particle sizes are defined by an uncoated PSD with a median of approximately 0.7 μm.

A twenty fifth aspect of the present disclosure includes a method according to the fifteenth aspect or the sixteenth aspect, wherein processing the common ceramic particles comprises milling the common ceramic particles to provide the first ceramic particles.

A twenty sixth aspect of the present disclosure includes a method according to the twenty fifth aspect, wherein milling the common ceramic particles comprises subjecting the common ceramic particles to turbulent mixing with and/or without ball media.

A twenty seventh aspect of the present disclosure includes a method according to the twenty fifth aspect or the twenty sixth aspect, further comprising mixing uncoated ceramic particles with the common ceramic particles prior to and/or after milling to provide the first ceramic particles.

A twenty eighth aspect of the present disclosure includes a method according to any one of the first through twenty seventh aspects, wherein one or more of the first ceramic particles and the second ceramic particles comprises alpha silicon carbide.

A twenty ninth aspect of the present disclosure includes a method according to any one of the first through twenty eighth aspects, wherein the first PSD and the second PSD are symmetric.

A thirtieth aspect of the present disclosure includes a method according to any one of the first through twenty eighth aspects, wherein the first PSD and the second PSD are asymmetric.

A thirty first aspect of the present disclosure includes a method according to any one of the first through twenty eighth aspects, wherein one of the first PSD and the second PSD is symmetric and the other of the first PSD and the second PSD is asymmetric.

A thirty second aspect of the present disclosure includes a method according to any one of the first through thirty first aspects, wherein a difference between the first mean and the second mean, the first median and the second median, and/or the first mode and the second mode is at least 10 μm.

A thirty third aspect of the present disclosure includes a method according to any one of the first through thirty first aspects, wherein a difference between the first mean and the second mean, the first median and the second median, and/or the first mode and the second mode is at least 25 μm.

A thirty fourth aspect of the present disclosure includes a method according to any one of the first through thirty first aspects, wherein a difference between the first mean and the second mean, the first median and the second median, and/or the first mode and the second mode is at least 50 μm.

A thirty fifth aspect of the present disclosure includes a method according to any one of the first through thirty fourth aspects, wherein the positive passage mold comprises a mold material that is meltable, sublimable, or otherwise heat-removeable, the mold material having a hardness configured to resist indentation from the first ceramic particles during pressing.

A thirty sixth aspect of the present disclosure includes a method according to the thirty fifth aspect, wherein the hardness of the mold material is in a range of from about 20 to about 50 Shore D durometer.

A thirty seventh aspect of the present disclosure includes a method according to the thirty sixth aspect, wherein the hardness of the mold material is in a range of from about 30 to about 40 Shore D durometer.

A thirty eighth aspect of the present disclosure includes a method according to any one of the first through thirty seventh aspects, wherein pressing the first ceramic particles, the second ceramic particles, and the positive passage mold comprises a pressing pressure in a range from about 30 to about 80 MPa.

A thirty ninth aspect of the present disclosure includes a fluidic module, comprising a monolithic closed-porosity ceramic body having a first region and a second region with the first region disposed between the second region, the first and second regions differing with respect to a common attribute of a ceramic material of the ceramic body; and a tortuous fluid passage extending through the ceramic body and surrounded by the first region such that the tortuous fluid passage is separated entirely from the second region, the tortuous fluid passage having an interior surface with a surface roughness of less than or equal to 5 μm Ra.

A fortieth aspect of the present disclosure includes a fluidic module according to the thirty ninth aspect, wherein the surface roughness is in a range of from 0.1 to 5 μm Ra.

A forty first aspect of the present disclosure includes a fluidic module according to the thirty ninth aspect, wherein the surface roughness is in a range of from 0.1 to 1 μm Ra.

A forty second aspect of the present disclosure includes a fluidic module according to any one of the thirty ninth through forty first aspects, wherein the ceramic material of the ceramic body has a density of at least 97% of a theoretical maximum density of ceramic material.

A forty third aspect of the present disclosure includes a fluidic module according to any one of the thirty ninth through forty first aspects, wherein the ceramic material of the ceramic body has a density of at least 98% of a theoretical maximum density of ceramic material.

A forty fourth aspect of the present disclosure includes a fluidic module according to any one of the thirty ninth through forty first aspects, wherein the ceramic material of the ceramic body has a density of at least 99% of a theoretical maximum density of ceramic material.

A forty fifth aspect of the present disclosure includes a fluidic module according to any one of the thirty ninth through forty fourth aspects, wherein the common attribute is density, the first region having a first density that is greater than a second density of the second region.

A forty sixth aspect of the present disclosure includes a fluidic module according to any one of the thirty ninth through forty fifth aspects, wherein the ceramic material of the ceramic body has a closed porosity of less than 3%.

A forty seventh aspect of the present disclosure includes a fluidic module according to any one of the thirty ninth through forty fifth aspects, wherein the ceramic material of the ceramic body has a closed porosity of less than 1.5%.

A forty eighth aspect of the present disclosure includes a fluidic module according to any one of the thirty ninth through forty fifth aspects, wherein the ceramic material of the ceramic body has a closed porosity of less than 0.5%.

A forty ninth aspect of the present disclosure includes a fluidic module according to any one of the thirty ninth through forty eighth aspects, wherein the common attribute is closed porosity, the first region having a first closed porosity that is less than a second closed porosity of the second region.

A fiftieth aspect of the present disclosure includes a fluidic module according to any one of the thirty ninth through forty ninth aspects, wherein the common material attribute is average grain size, the first region having a first average grain size that is less than a second average grain size of the second region.

A fifty first aspect of the present disclosure includes a fluidic module according to any one of the thirty ninth through fiftieth aspects, wherein the second region comprises at least two outer layers and the first region comprises an inner layer disposed between the at least two outer layers.

A fifty second aspect of the present disclosure includes a fluidic module according to the fifty first aspect, wherein the at least two outer layers and the inner layer are planar layers arranged between major surfaces of the fluidic module.

A fifty third aspect of the present disclosure includes a fluidic module according to any one of the thirty ninth through fiftieth aspects, wherein the first region has a substantially uniform thickness extending substantially perpendicularly from the interior surface of the tortuous fluid passage.

A fifty fourth aspect of the present disclosure includes a fluidic module according to the fifty third aspect, wherein the thickness of the first region is in a range of from about 50 μm to about 500 μm.

A fifty fifth aspect of the present disclosure includes a fluidic module according to any one of the thirty ninth through fifty fourth aspects, wherein at least one interface between the first region and the second region comprises the ceramic material, and wherein the value of the common attribute of the at least one interface is between the value of the common attribute of the first region and the value of the common attribute of the second region.

A fifty sixth aspect of the present disclosure includes a fluidic module according to the fifty fifth aspect, wherein the at least one interface includes a plurality of interfaces and the value of the common attribute of each interface is between the value of the common attribute of the first region and the value of the common attribute of the second region.

A fifty seventh aspect of the present disclosure includes a fluidic module according to the fifty fifth aspect or the fifty sixth aspect, wherein the common attribute of the at least one interface and/or all the interfaces transitions gradually between the common attribute of the first region and the common attribute of the second region.

A fifty eighth aspect of the present disclosure includes a fluidic module according to any one of the thirty ninth through fifty seventh aspects, wherein the interior surface of tortuous fluid passage comprises a floor and a ceiling separated by a height h and two opposing sidewalls joining the floor and the ceiling, the sidewalls separated by a width W measured perpendicular to the height h and at a position corresponding to one-half of the height h wherein the height h of the tortuous fluid passage is in the range of from 0.1 to 20 mm.

### BRIEF DESCRIPTION OF THE DRAWINGS

FIG. 1 is a plan view outline of a fluidic passage of a type useful in fluidic modules for flow reactors and showing certain features of the fluidic passage;

FIG. 2 is a perspective view of an exterior of a ceramic fluidic module according to embodiments;

FIG. 3 is a cross-sectional view of a ceramic fluidic module showing a portion of a fluidic passage extending therethrough according to embodiments;

FIG. 4 is a cross-sectional view of a ceramic fluid module with first and second regions formed respectively from coarse and fine ceramic particles according to embodiments;

FIG. 5 is a cross-sectional view of a ceramic fluid module with first and second regions formed respectively from coarse and fine ceramic particles according to embodiments;

FIG. 6 is a flow chart showing embodiments of a method of forming the ceramic fluidic modules of FIG. 4 and FIG. 5;

FIGS. 7A-7G are a stepwise series of cross-sectional representations depicting aspects of the method of FIG. 6 for forming the ceramic fluidic module of FIG. 4;

FIGS. 8A-8E are a stepwise series of cross-sectional representations depicting aspects of the method of FIG. 6 for forming the ceramic fluidic module of FIG. 5;

FIGS. 9A-9C are a stepwise series of cross-sectional representations depicting common aspects of the method of FIG. 6 for forming the ceramic fluidic modules of FIG. 4 and FIG. 5;

FIG. 10 is a plot of channel surface roughness Ra measurements from samples formed from sieved SiC powders having different particle sizes and a sample formed from an unmodified commercial SiC powder according to Example 1;

FIG. 11 is a cross-section of a sample after a debinding process, showing a fine SiC powder layer surrounding a channel and coarse SiC powder layers positioned above and below the fine SiC powder layer according to Example 2;

FIG. 12 is a photograph showing several passage molds with some of the passage molds dip-coated in a SiC slip according to Example 3;

FIG. 13 is a photograph of a sample with an internal feature formed from one of the dip-coated passage molds of FIG. 12 after the sample has been pressed, debound, and sectioned to expose the smooth surface of the internal feature;

FIG. 14 is a surface profile measurement of a sample with an internal channel formed from a wax bar partially dip-coated in the SiC slip of FIG. 12, the measurement encompassing a portion of the internal channel formed from an uncoated portion of the wax bar, and

FIG. 15 is a surface profile measurement of the sample of FIG. 14, the measurement encompassing a portion of the internal channel formed from a coated portion of the wax bar.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other or a corresponding ideal quantity (e.g., all, each, every), or within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “ceramic particles” whether by itself or preceded by any one of the terms “coated,” “binder-coated,” “ready-to-press,” “RTP,” and/or similar variations thereof refers to ceramic particles that include binder and/or lubricants that facilitate pressing of the ceramic particles. The term “ceramic particles” has the meaning immediately above unless the term is preceded by any one or more of the terms “non-binder-coated,” “non-coated,” “uncoated,” “raw,” or it is otherwise indicated that no binder and/or lubricants have been added to the ceramic particles.

As used herein, a “particle size distribution” or “PSD” of a powder or granular material, such as the ceramic powders and ceramic particles described herein, is a list of values or a mathematical function that defines the relative quantity of particles present according to size. A PSD is useful way to describe the size(s) of the particles in a powder. A PSD can be described by numerous features of the distribution such as mean, median, mode, and width. Mean is a calculated value similar to the concept of average. There are multiple definitions for mean because the mean value is associated with the basis of the distribution calculation (number, surface, volume). The various mean calculations are defined by known standards such as ISO 9276-2:2001. Median values are defined as the value where half of the population resides above this point and half resides below this point. For particle size distributions, the median is called the D50. The D50 is the size in microns that splits the distribution with half above and half below this diameter. The mode is the peak of the frequency distribution, or the highest peak seen in the distribution. The mode represents the particle size (or size range) most commonly found in the distribution. The values for particles size disclosed herein refer to the diameter or the equivalent spherical diameter for the particles unless indicated otherwise.

A frequency distribution having just one peak is called “unimodal” or “monomodal.” A typical example of a unimodal distribution is the normal distribution, which is also symmetric. For symmetric distributions, all central values are equivalent such that mean=median=mode. Many unimodal (single-peak) frequency distributions, by contrast, are asymmetric (e.g. “left-skewed” or “right-skewed”). For asymmetric or non-symmetric distributions, the mean, median, and mode will be three different values. In a unimodal PSD, particles of a moderate particle size typically have the greatest frequency. There are no further main modes in the PSD. For production-related reasons, there can be one or more secondary modes at particle sizes of no relevance for the measurement. The corresponding unimodal PSD may have a sharp or broad configuration around the mode having the median particle size. In the case of a “sharp” PSD, the frequency decreases significantly proceeding from the mode. In the case of a “broad” PSD, particle sizes having a more significant distance from the median particle size also still have a relevant frequency.

As used herein, a “tortuous” passage refers to a passage having no line of sight directly through the passage and with a path of the passage having at least two differing radii of curvature, the path of the passage being defined mathematically and geometrically as a curve formed by successive geometric centers, along the passage, of successive minimum-area planar cross sections of the passage (that is, the angle of a given planar cross section is the angle which produces a minimum area of the planar cross section at the particular location along the passage) taken at arbitrarily closely spaced successive positions along the passage. Typical machining-based forming techniques are generally inadequate to form such a tortuous passage. Such passages may include a division or divisions of a passage into subpassages (with corresponding subpaths) and a recombination or recombinations of subpassages (and corresponding subpaths).

As used herein a “monolithic” ceramic structure does not imply zero inhomogeneities in the ceramic structure at all scales. A “monolithic” ceramic structure or a “monolithic” ceramic fluidic module, as the term “monolithic” is defined herein, refers to a ceramic structure or fluidic module, with one or more tortuous passages extending therethrough, in which no (other than the passage(s)) inhomogeneities, openings, or interconnected porosities are present in the ceramic structure having a length greater than the average perpendicular depth d of the one or more passages P from the external surface of the structure or module 300, as shown in FIG. 3. Providing such a monolithic ceramic structure or monolithic ceramic flow module helps ensure fluid tightness and good pressure resistance of a flow reactor fluidic module or similar product.

“Monolithic” as used herein has the meaning provided above. However, Applicant reserves a right to otherwise define monolithic if expressly so stated, such as in the claims, where monolithic may alternatively be defined as a body of sintered polycrystalline ceramic material with a chain of grains having a continuous and uniform distribution through an entirety of the body in any direction, such as when grain growth occurs concurrently during a single sintering cycle, yet where the body may include internal passages, as disclosed herein, and interstitial pores between grains, and optionally where most interstitial pores have a maximum crosswise dimension of less than 5 μm, such as in the range of from 2 to 3 μm, and/or where the body is free of separate components (e.g. halves of the body) bonded to one another at a joint (observable and/or detectible), such as at a joining plane in the case of components prepared via a sandwich assembly approach. A joint may be observable and/or detectible, for example, by the naked eye, microscopic analysis of cross sections, scanning electron microscopy (SEM), far-infrared reflectivity spectroscopy, electron backscatter diffraction (EBSD), surface profilometer measurement after etching, compositional variations through Auger electron spectroscopy (AES), X-ray photoelectron spectroscopy (XPS), and/or x-ray CT scanning.

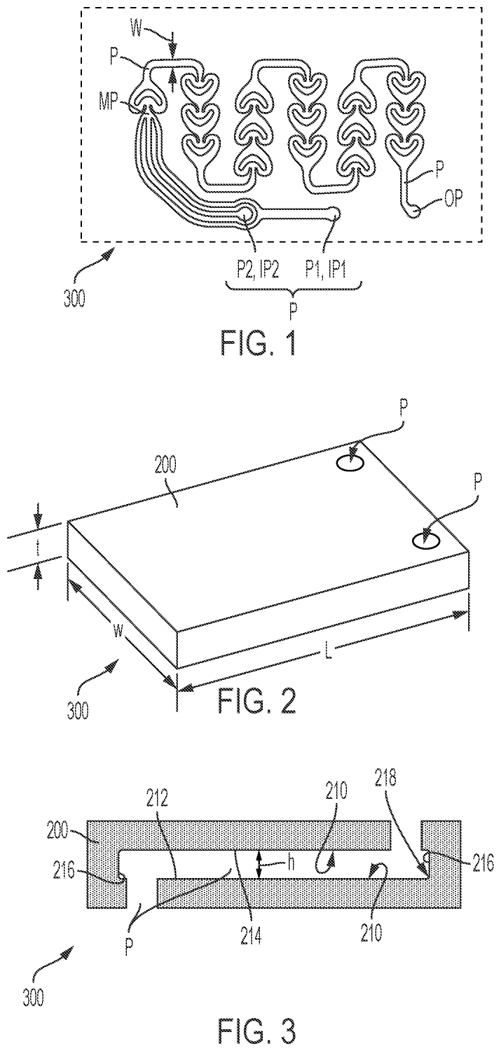

A ceramic fluidic module 300 for a flow reactor (not shown) is disclosed in FIGS. 1-3. The fluidic module 300 comprises a monolithic closed-porosity ceramic body 200 and a tortuous fluid passage P extending along a path through the ceramic body 200. The ceramic body 200 is formed from a ceramic material that includes any pressable powder that is held together by a binder and thermally processed to fuse the powder particles together into a structure. The ceramic material in some embodiments includes oxide ceramics, non-oxide ceramics, glass-ceramics, glass powders, metal powders, and other ceramics that enable high density, closed-porosity monolithic structures. Oxide ceramics are inorganic compounds of metallic (e.g., Al, Zr, Ti, Mg) or metalloid (Si) elements with oxygen. Oxides can be combined with nitrogen or carbon to form more complex oxynitride or oxycarbide ceramics. Non-oxide ceramics are inorganic, non-metallic materials and include carbides, nitrides, borides, silicides and others. Some examples of non-oxide ceramics that can be used for the ceramic body 200 include boron carbide (B₄C), boron nitride (BN), tungsten carbide (WC), titanium diboride (TiB₂), zirconium diboride (ZrB₂), molybdenum disilicide (MoSi₂), silicon carbide (SiC), silicon nitride (Si₃N₄), and sialons (silicon aluminum oxynitrides). The ceramic body 200 in the exemplary embodiment is formed from SiC.

The tortuous fluid passage P, according to embodiments, comprises a floor 212 and a ceiling 214 separated by a height h and two opposing sidewalls 216 joining the floor 212 and the ceiling 214. The sidewalls are separated by a width W (FIG. 1) measured perpendicular to the height h and the direction along the passage (corresponding to the predominant flow direction when in use). Further, the width W is measured at a position corresponding to one-half of the height h. According to embodiments, the height h of the tortuous fluid passage P is in the range of from 0.1 to 20 mm, or from 0.2 to 15 mm, or from 0.3 to 12 mm. The width W of the tortuous fluid passage P can vary depending on the processes and/or reactions configured to take place along each position or region along the path.

According to embodiments, the interior surface 210 of the fluid passage P where the sidewalls 216 meet the floor 212 has a radius curvature (at reference 218) of greater than or equal to 0.1 mm, or greater than or equal to 0.3 mm, or even greater than or equal to 0.6 mm, or 1 mm or 5 mm, 1 cm or 2 cm. The interior surface 210 of the fluid passage P, when viewed in a planar cross section oriented normal to the path, can have the same geometry and/or different geometries at different positions along the path. For instance, the interior surface 210 in some embodiments can have a cross-sectional shape in the form of a square, a rectangle, a circle, an oval, a stadium (i.e., a circle elongated at a mirror plane), and other shapes. The relative size of the same or different geometries can also vary along the path. The transition of sizes and/or geometries of the interior surface along the path are gradual to avoid introducing step-like structures within the fluid passage P. The interior surface 210 in embodiments preferably has a circular cross-sectional shape, which enables higher pressure resistance.

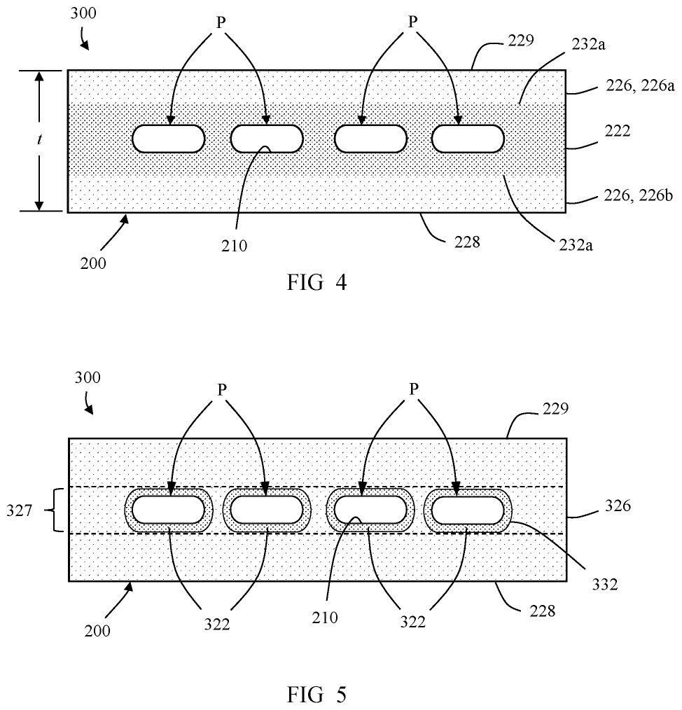

According to embodiments, the monolithic closed-porosity ceramic body 200 of the fluidic module 300 has a first region 222, 322 and a second region 226, 326 with the first region 222, 322 disposed between the second region 226, 326 as shown in FIGS. 4 and 5. The ceramic body 200 has a thickness t in a direction extending between opposing first and second major surfaces 228, 229 of the ceramic body 200. The first major surface 228 and the second major surface 229 in embodiments are defined by the second region 226, 326, and the thickness extends approximately perpendicularly to the first and second major surfaces 228, 229. The first region 222, 322 and the second region 226, 326 are configured to differ from one another with respect to a common attribute of a ceramic material that forms the ceramic body 200.

As used herein, a “common attribute” of the ceramic material refers to the same physical property or attribute of the ceramic material that is concurrently measurable and/or otherwise determinable in both the first region 222, 322 and the second region 226, 326. To further explain by example, if the common attribute is density, the density of the ceramic material that forms the first region 222, 322 of the ceramic body 200 will be different than the density of the ceramic material that forms the second region 226, 326 of the ceramic body to some measurable and/or otherwise determinable degree. The common attribute in embodiments is an average value of the physical property or attribute throughout the entire volume of the first region 222, 322 or the second region 226, 326. As described later in this disclosure, the common attribute can be caused to differ by forming the first and second regions from respective quantities of ceramic particles that are the same type of ceramic material, but that differ with respect to their particle sizes. For example, as described later in this disclosure, the first region 222, 322 can be formed from fine SiC particles and the second region 226, 326 can be formed from coarse SiC particles.

The common attribute in embodiments can be a density of the ceramic material in each of the first region 222, 322 and the second region 226, 326 after sintering of the ceramic body 200. The first region is formed or otherwise configured to have a first density. The second region is formed or otherwise configured to have a second density. The first density of the first region 222, 322 is greater than the second density of the second region 226, 326. The first density and the second density can be the average or mean density of all portions of the ceramic body 200 that comprise the first region 222, 322 and the second region 226, 326, respectively. Without being bound by theory, it is believed that the first density will be greater than the second density because the tighter packing of the smaller particles will result in smaller interstitial voids between them after pressing such that during firing the voids will close more effectively due to shorter surface diffusion distances. An exemplary standard for density measurement includes, for example, ASTM C329-88(2020) “Standard Test Method for Specific Gravity of Fired Ceramic Whiteware Materials.”

The common attribute in embodiments can be a porosity of the ceramic material in each of the first region 222, 322 and the second region 226, 326 after sintering of the ceramic body 200. The first region is formed or otherwise configured to have a first porosity. The second region is formed or otherwise configured to have a second porosity. The first porosity of the first region 222, 322 is less than the second porosity of the second region 226, 326. The first porosity and the second porosity can be the average or mean porosity of all portions of the ceramic body 200 that comprise the first region 222, 322 and the second region 226, 326, respectively. Without being bound by theory, it is believed that the first porosity will be less than the second porosity because there will be more effective void size reduction during firing for the smaller particles.

In embodiments, the porosity of the ceramic material can be characterized by the type or nature of the porosity, which includes open (effective) porosity and closed (ineffective) porosity. The open porosity of a material refers to the fraction of the total volume in which fluid flow can effectively take place and excludes closed or non-connected cavities, pores, or voids. The closed porosity of a material refers to the fraction of the total volume in which fluids or gases are present but in which fluid flow cannot effectively take place and includes closed cavities, pores, or voids. The sum of open porosity and closed porosity is sometimes referred to as total porosity. The porosity of the ceramic material in embodiments can also be characterized by the size of the interstitial pores or voids.

In embodiments, at least one of (i) the first closed porosity of the first region 222, 322 is less than the second closed porosity of the second region 226, 326, (ii) the first open porosity of the first region 222, 322 is less than the second open porosity of the second region 226, 326, and (iii) the first void sizes of the first region 222, 322 are less than the second void sizes of the second region 226, 326. Exemplary standards for porosity measurement include, for example, ASTM D4404-18 “Standard Test Method for Determination of Pore Volume and Pore Volume Distribution of Soil and Rock by Mercury Intrusion Porosimetry,” ASTM D4284-12(2017)e1 “Standard Test Method for Determining Pore Volume Distribution of Catalysts and Catalyst Carriers by Mercury Intrusion Porosimetry,” ASTM C949-80(2020) “Standard Test Method for Porosity in Vitreous Whitewares by Dye Penetration.”

The common attribute in embodiments can be a grain size of the ceramic material in each of the first region 222, 322 and the second region 226, 326 after sintering of the ceramic body 200. The first region is formed or otherwise configured to have a first grain size. The second region is formed or otherwise configured to have a second grain size. The first grain size of the first region 222, 322 is less than the second grain size of the second region 226, 326. The first grain size and the second grain size can be the average or mean grain size of all portions of the ceramic body 200 that comprise the first region 222, 322 and the second region 226, 326, respectively. An exemplary standard for grain size measurement includes, for example, ASTM C1730-17 “Standard Test Method for Particle Size Distribution of Advanced Ceramics by X-Ray Monitoring of Gravity Sedimentation.”

With continued reference to FIGS. 4 and 5, the tortuous fluid passage P is surrounded by the first region 222, 322 such that the tortuous fluid passage P is separated from the second region 226, 326. In the embodiments shown, the first region 222, 322 surrounds the tortuous fluid passage P such that the tortuous fluid passage P is separated entirely from the second region 226, 326 at least within a planar region that extends laterally through the ceramic body 200. The planar region shown in FIG. 4 corresponds to the first region 222. The planar region 327 shown in FIG. 5 extends laterally through the ceramic body 200 and has a height that corresponds approximately to an outermost extent of the first region 322 in the direction of the thickness t of the ceramic body 200. The dashed lines extending from the bracket with reference number 327 in FIG. 5 are included only to delineate the planar region and do not represent additional structure in the ceramic body 200. The planar region 222, 327 is configured to be centered about a position and/or extent of the tortuous fluid passage P through the ceramic body 200. In the embodiments shown, the planar region 222, 327 is centered about a midpoint between the opposed major surfaces 228, 229. The planar region 222, 227 in embodiments can be spaced from the midpoint.

The tortuous fluid passage P has an interior surface 210. In portions of the ceramic body 200 in which the first region 222, 322 surrounds the tortuous fluid passage P, such as within the planar region, the interior surface 210 is defined by the ceramic material of first region 222, 322. The interior surface 210 has a surface roughness in a range of less than or equal to 5 μm Ra, or from 0.1 to 5 μm Ra or even from 0.1 to 1 μm Ra, which is generally lower than SiC fluidic modules have previously achieved. The lower surface roughness of the interior surface 210 within the portions defined by the first region is achievable due to the common attribute of the ceramic material of the first region 222, 322 as compared to the common attribute of the ceramic material of the second region 226, 326.

The surface roughness of the interior surface 210 occurs along any measured profile of the interior surface 210. For instance, when viewed in a planar cross section oriented normal to the path, the interior surface 210 defines an interior profile that completely encircles the path of the passage P. The surface roughness of the interior surface 210 occurs along an entirety of the interior profile at every position along the path. The interior surface 210 does not have any joints or seams or steps or discontinuities along the interior surface 210 due to the monolithic structure of the ceramic body 200.

The first region 222, 322 and the second region 226, 326 can have different configurations according to embodiments of the fluidic module 300. With reference to FIG. 4, the second region can include at least two outer layers 226a, 226b and the first region can include an inner layer 222 disposed between the two outer layers 226a, 226b. The at least two outer layers 226a, 226b and the inner layer 222 are configured as planar layers that are arranged serially between the major surfaces 228, 229 of the fluidic module 300. A first interface 232a is disposed between a first outer layer 226a of the second region 226 and the inner layer of the first region 222. A second interface 232b is disposed between a second outer layer 226b of the second region 226 and the inner layer of the first region 222. The first interface 232a and the second interface 232b are illustrated in FIG. 4 at the intersections of the loose pattern fill associated with first and second outer layers 226a, 226b and the compact pattern fill associated with the inner layer 222. The first interface 232a and the second interface 232b are substantially free or free of voids between the first region 222 and the second region 226.

In embodiments according to FIG. 4, at least one or both of the first interface 232a and the second interface 232b can have a thickness that is zero such that the first region 222 transitions abruptly into the second region 226. In such embodiments, the common attribute of the ceramic material of the first region (e.g., the first density, the first porosity, and/or the first grain size) transitions abruptly into the common attribute of the ceramic material of the second region (e.g., the second density, the second porosity, and/or the second grain size).

In embodiments according to FIG. 4, at least one or both of the first interface 232a and the second interface 232b can have a thickness that is greater than zero and comprises the ceramic material. In such embodiments, the common attribute of the first interface 232a and/or the common attribute of the second interface 232b can be between the common attribute of the first region 222 and the common attribute of the second region 226 such that the first region 222 transitions gradually and/or in a stepped manner into the second region 226.

With reference to FIG. 5, the second region can include a bulk 326 disposed between the major surfaces 228, 229 and the first region can include one or more contoured regions 322 disposed within the bulk 326. The one or more contoured regions 322 in embodiments have a thickness that extends perpendicularly from the interior surface 210 of the tortuous fluid passage P. The thickness of the one or more contoured regions 322 can be substantially uniform as shown in FIG. 5. As used herein, a substantially uniform thickness can be a thickness that deviates by no more than 10%, or 5%, or 2% from an average thickness of the contoured regions 322 over a given length of the passage P, for example, the 75% of the passage length, or 85% of the passage length or 100% of the passage length. The thickness of the one or more contoured regions 322 in embodiments can vary along the path of the tortuous fluid passage P. The thickness of the one more contoured regions 322 can be in a range of at least about 50 μm to about 500 μm.

An interface 332 is disposed between the bulk 326 of the second region and the one or more contoured regions 322 of the first region. The interface(s) 332 are illustrated in FIG. 5 at the intersections of the loose pattern fill associated with bulk 326 of the second region and the compact pattern fill associated with the one or more contoured regions 322 of the first region. The solid lines depicted at the interface(s) 332 are used only to clarify the intersections between the first region 322 and the second region 326. In practice, the interface(s) 332 can be rough at the granular scale where the ceramic material of the first region 322 and the second region 326 contacts one another. The interface(s) 332 are substantially free or free of voids between the first region 322 and the second region 326. The interface(s) 332 of FIG. 5 can have the same thicknesses and/or transitions as described above with respect to the interfaces 232a, 232b of FIG. 4.

The first density and the second density of the first region 222, 322 and the second region 226, 326, respectively, are each at least 95% of a theoretical maximum density of the ceramic material, or even of at least 96, 97, 98, or 99% of the theoretical maximum density. The theoretical maximum density (also known as maximum theoretical density, theoretical density, crystal density, or x-ray density) of a polycrystalline material, such as SiC, is the density of a perfect single crystal of the sintered material. Thus, the theoretical maximum density is the maximum attainable density for a given structural phase of the sintered material.

In the exemplary embodiment, the ceramic material is alpha silicon carbide (α-SiC) with a hexagonal 6H structure. The theoretical maximum density of sintered SiC(6H) is 3.214±0.001 g/cm³. Munro, Ronald G., “Material Properties of a Sintered α-SiC,” Journal of Physical and Chemical Reference Data, 26, 1195 (1997). The ceramic material in embodiments can include a different crystalline form of SiC or a different ceramic altogether. The theoretical maximum density of other crystalline forms of sintered SiC can differ from the theoretical maximum density of sintered SiC(6H), for example, within a range of 3.166 to 3.214 g/cm³. Similarly, the theoretical maximum density of other sintered ceramics also differs from that of sintered SiC(6H). As used herein, a “high density” ceramic body is a ceramic body in which the sintered ceramic material of the ceramic body has a density of at least 95% of the theoretical maximum density of the ceramic material.

In embodiments in which the common attribute is closed porosity, the corresponding respective closed porosities of the first region 222, 322 and the second region 226, 326 are each less than 3%, or less than 1.5%, or even less than 0.5%. In embodiments in which the common attribute is open porosity, the corresponding respective open porosities of the first region 222, 322 and the second region 226, 326 are each less than 1%, or even of less than 0.5%, 0.4%, 0.2% or 0.1%. As used herein, a “closed-porosity” ceramic body is a ceramic body in which the ceramic material of the ceramic body exhibits a pore topology that is closed such that the pores or cells in the material are isolated or connected only with adjacent pores or cells and have no permeability to fluid.

According to embodiments, the ceramic body 200 of the fluidic module 300 has an internal pressure resistance under pressurized water testing of at least 50 bar, or even at least 100 bar, or 150 bar.

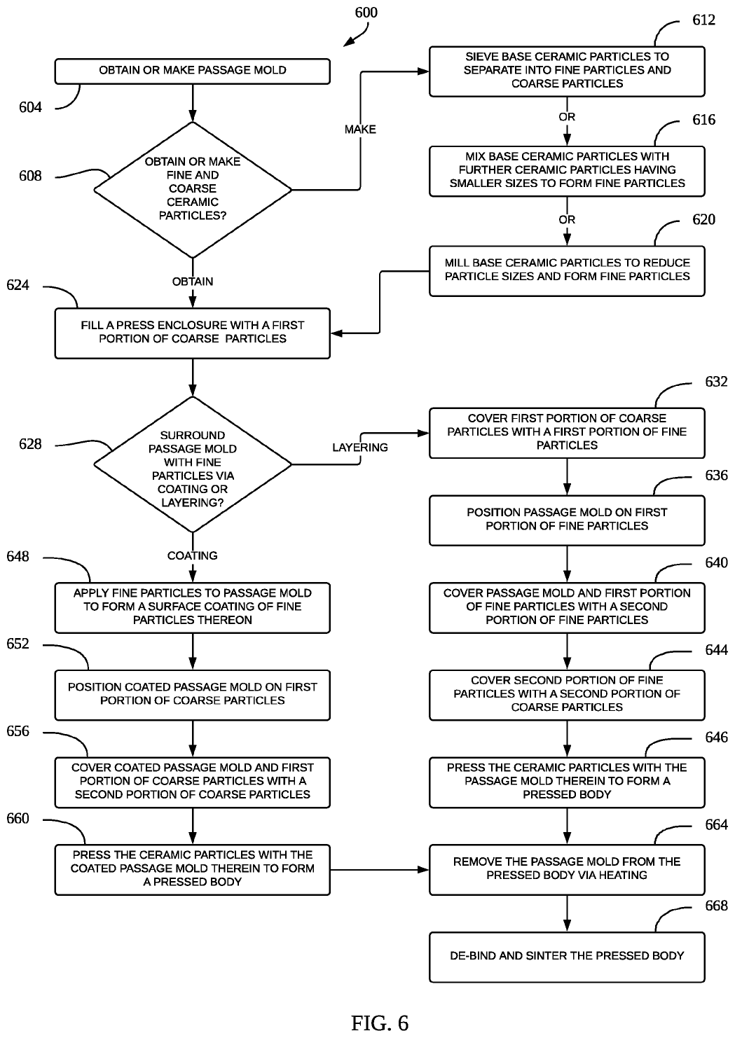

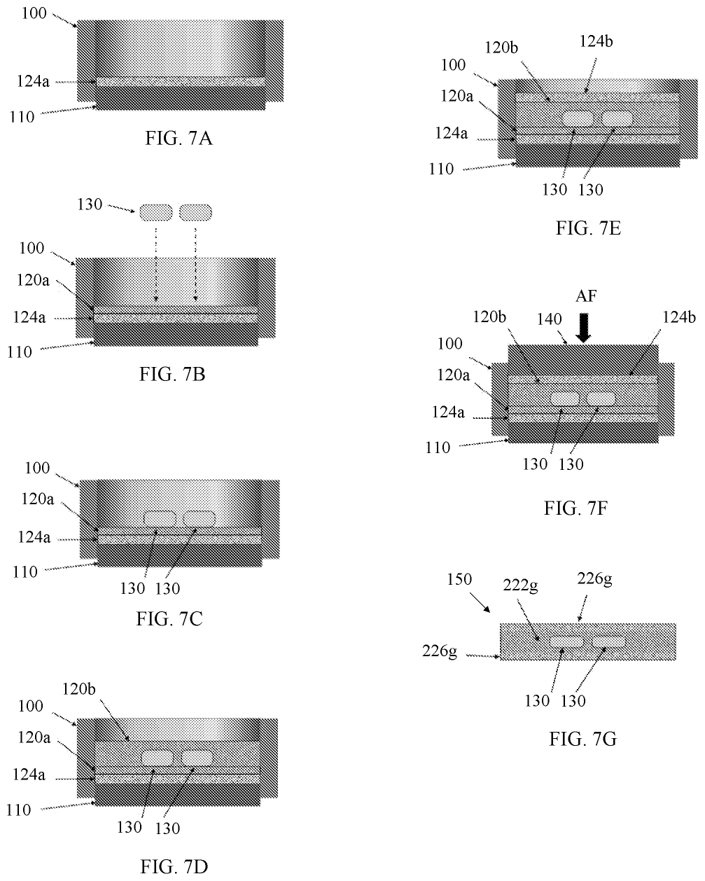

FIG. 6 is a process diagram of a method 600 of forming a ceramic fluidic module for a flow reactor having one or more of the desirable properties disclosed herein. The method 600 is described with reference to FIGS. 7A-7G, FIGS. 8A-8E, and FIGS. 9A-9C, which depict cross-sectional representations of aspects of forming the ceramic fluidic modules of FIGS. 4 and 5. The method 600 includes obtaining or making a positive passage mold (block 604). The positive passage mold is configured to define a passage that has a tortuous shape. The positive passage mold can be made by molding, machining, 3D printing, or other suitable forming techniques or combinations thereof. The positive passage mold comprises a mold material that is meltable, sublimable, or otherwise heat-removeable. The mold material in embodiments is a relatively incompressible material.

The method 600 in embodiments can include obtaining or processing a ceramic powder to provide a quantity of fine ceramic particles and a quantity of coarse ceramic particles that is separate from the quantity of fine ceramic particles (block 608). As used herein, “fine ceramic particles” and “coarse ceramic particles” can be interchangeably referred to as “first ceramic particles” and “second ceramic particles,” respectively. The first ceramic particles and the second ceramic particles have first particle sizes and second particle sizes, respectively. In embodiments, the first particle sizes of the first ceramic particles are smaller than the second particle sizes of the second ceramic particles. The first particle sizes of the first ceramic particles are defined by a first PSD with a first mean, a first median, and a first mode. The second particle sizes of the second ceramic particles are defined by a second PSD with a second mean, a second median, and a second mode. In embodiments, at least one of (i) the first mean is less than the second mean, (ii) the first median is less than the second median, and (iii) the first mode is less than the second mode.

In embodiments in which the ceramic powder is obtained, the ceramic powder can be one or more commercial ready-to-press (RTP) ceramic powders that provides one or more of the first ceramic particles and the second ceramic particles in the respective quantities. For example, the second ceramic particles can be provided as a standard spray dried ceramic powder and the first ceramic particles can be provided as a custom spray dried ceramic powder formulated with granule diameters that are smaller than the granules of the standard spray dried ceramic powder.

In embodiments in which the ceramic powder is processed, the ceramic powder prior to processing can include base or common ceramic particles that have common particle sizes defined by a common particle size distribution (PSD) with a common mean, a common median, and a common mode. In embodiments, the common ceramic particles prior to processing encompass one or more of the first ceramic particles and the second ceramic particles. In other words, one or more of the first ceramic particles and the second ceramic particles are present in the common ceramic particles and/or are derivable from the common ceramic particles. The method 600 in embodiments in which the ceramic powder is processed includes processing the common ceramic particles to provide the first ceramic particles, the second ceramic particles, or both the first ceramic particles and the second ceramic particles in respective quantities.

The processing of the common ceramic particles to provide the first ceramic particles and/or the second ceramic particles can include one or more approaches that can be performed individually or in combination with one another. In one approach, the processing of the common ceramic particles comprises sieving the common ceramic particles with a sieving mesh that has a mesh size such that the sieving mesh is configured to separate the common ceramic particles into the first ceramic particles and the second ceramic particles (block 612). In embodiments, at least one sieving mesh is used to separate the common ceramic particles into two powder groups: ceramic powder that includes the first ceramic particles and ceramic powder that includes the second ceramic particles. The first or fine ceramic particles are the ceramic particles that fall through the sieving mesh and are sometimes referred to as the “minus” or “−” product. The second or coarse ceramic particles are the ceramic particles that are retained in the sieving mesh and are sometimes referred to as the “plus” or “+” product.

After sieving the common ceramic particles (block 612), substantially all of the first ceramic particles (e.g., greater than 99%/o of the first ceramic particles) have first particle sizes that are less than the mesh size and substantially all of the second ceramic particles (e.g., greater than 97% of the second ceramic particles) have second particle sizes that are greater than or equal to the mesh size. It will be appreciated that the second ceramic particles can include a small quantity of the first ceramic particles due to the nature of the sieving process. After sieving, the first ceramic particles can have the first PSD with corresponding first mean, first median, and first mode. After sieving, the second ceramic particles can have the second PSD with corresponding second mean, second median, and second mode. In embodiments after sieving, at least one of (i) the first mean is less than the second mean, (ii) the first median is less than the second median, and (iii) the first mode is less than the second mode. In embodiments, the first particle sizes can be at least about 1 μm, or at least about 10 μm, at least about 20 μm, at least about 30 μm, at least about 40 μm, at least about 45 μm, or even at least about 50 μm. The second particle sizes in embodiments can be at most about 500 μm, or at most about 400 μm, at most about 350 μm, at most about 300 μm, at most about 275 μm, at most about 250 μm, or even at most about 225 μm. The second particle sizes in other embodiments can be at most about 200 μm, at most about 100 μm, or even at most about 70 μm.

In embodiments in which the method 600 includes sieving the common ceramic particles (block 612), the mesh size is selected to separate a sufficient quantity of the first ceramic particles from the common ceramic particles. While use of first ceramic particles with very fine particle sizes (e.g., 50 μm or less) for forming the first region 222, 322 of the ceramic body 200 will yield the smoothest interior surface 210 of the fluid passage P, as demonstrated herein, a large quantity of the common ceramic particles may need to be processed to obtain a sufficient quantity of the first ceramic particles. Therefore, the mesh size is selected to separate a sufficient quantity of the first ceramic particles from the common ceramic particles even if the first particle sizes are not the finest possible.

In embodiments, the mesh size is selected to be a value within a range centered relative to one or more of a mean, a median, and a mode of the common PSD. A mesh size selected in this manner can help ensure a sufficient quantity of the first ceramic particles is available to be separated from the common ceramic particles. The range in embodiments can be centered at, to the left of (towards smaller sizes), or to the right of (towards larger sizes) the one or more of the mean, the median, and the mode of the common PSD. The mesh size in embodiments can be a value in a range of from about 70 μm to about 210 μm, or a range of from about 80 μm to about 200 μm, or a range from about 90 μm to about 190 μm, or a range from about 100 μm to about 180 μm, or a range from about 110 μm to about 170 μm, or even a range from about 120 μm to about 160 μm. In embodiments, the mesh size is selected to separate approximately 33 wt % of the common ceramic particle as the first ceramic particles to provide a sufficient quantity of the first ceramic particles.

In another approach, the processing of the common ceramic particles comprises mixing uncoated ceramic particles with the common ceramic particles to provide the first ceramic particles (block 616). In embodiments, the common ceramic particles can be mixed with the uncoated ceramic particles to also provide the second ceramic particles. The uncoated or raw ceramic particles are ceramic particles that do not include binder and/or lubricants, which can be added to facilitate pressing of the ceramic particles. In embodiments, the particle sizes of the uncoated ceramic particles are smaller than the particle sizes of the common ceramic particles. The uncoated ceramic particles have an uncoated PSD with an uncoated mean, uncoated median, and uncoated mode. In embodiments, at least one of (i) the uncoated mean is less than the common mean, (ii) the uncoated median is less than the common median, and (iii) the uncoated mode is less than the common mode. In embodiments, the uncoated ceramic particles are raw alpha SiC particles with an uncoated median or D50 of approximately 0.7 μm. The uncoated ceramic particles are mixed with the common ceramic particles to adjust the common PSD. Specifically, by mixing the uncoated ceramic particles with the common ceramic particles, the uncoated particle sizes reduce one or more of the common mean, the common median, and the common mode.

The common ceramic particles and the uncoated ceramic particles can be mixed in various proportions to form a range of powder compositions for the first ceramic particles. The first ceramic particles in embodiments can include from about 50 wt % to about 85 wt % of the common ceramic particles and from about 15 wt % to about 50 wt % of the uncoated ceramic particles. Some example compositions for the first ceramic particles can include a 85/15 mix with 85 wt % common ceramic particles and with 15 wt % uncoated ceramic particles, a 80/20 mix with 80 wt % common ceramic particles with 20 wt % uncoated ceramic particles, a 75/25 mix with 75 wt % common ceramic particles and with 25 wt % uncoated ceramic particles, and a 50/50 mix with 50 wt % common ceramic particles and with 50 wt % uncoated ceramic particles. If the common ceramic particles are mixed with the uncoated ceramic particles to also provide the second ceramic particles, the mixture will be such that the first ceramic particles and the second ceramic particles have the particle size relationships disclosed herein. In embodiments, approximately 60 wt % may be a limit to the proportion of uncoated ceramic particles in the compositions since the uncoated ceramic particles may not sufficiently adhere together in the interstitials of the spray dried granules.

In yet another approach, the processing of the common ceramic particles comprises milling the common ceramic particles to provide the first ceramic particles (block 620). In this approach, the common ceramic particles are subjected to a milling process to reduce the common particle sizes. In embodiments, the common ceramic particles can be milled to also provide the second ceramic particles. Various types of milling processes can be used individually or in combination with one another. One type of milling includes containerized batch mixing with mixing blade inside rotating container. This type of milling can be accomplished with a Readco mixer, Readco Kurimoto LLC, model RK-Labmaster, 65 lbs (York, PA, USA). Another type of milling includes turbulent mixing with or without ball media. This type of milling can be accomplished with a CMR Turbula mixer, Type T2C, Willy A. Brachofen AG Machinenfabrik (Basel/Schweiz, Germany). Another type of milling includes ball milling with or without media. This type of milling can be accomplished with a CMR ball mill, Paul O. Abbe ball mill, model MJRM-253643 (Wood Dale, IL, USA). In this approach, uncoated ceramic particles can be added to the common ceramic particles before and/or after milling to further reduce one or more of the common mean, the common median, and the common mode. If the common ceramic particles are milled to also provide the second ceramic particles, the milling process will be such that the first ceramic particles and the second ceramic particles have the particle size relationships disclosed herein.

The first or fine ceramic particles and the second or coarse ceramic particles can each be obtained or made to have particle sizes with specified features and relationships. In embodiments, the first PSD and the second PSD can each be symmetric or asymmetric. Alternatively, in embodiments, one of the first PSD and the second PSD can be symmetric and the other of the first PSD and the second PSD can be asymmetric. In embodiments, a difference between the first mean and the second mean, the first median and the second median, and/or the first mode and the second mode can be at least 10 μm, or at least 25 μm, or at least 50 μm, or at least 75 μm, or at least 100 μm, at least 125 μm, at least 150 μm, at least 200 μm, or even at least 250 μm. Regardless of the magnitude of the difference, the mean, median, and mode of each of the first PSD and of the second PSD have same the relationship relative to one another as previously described herein.

Once the first ceramic particles and/or the second ceramic particles are obtained or made (blocks 608, 612, 616, 620), the method 600 further includes filling a press enclosure (or die) 100, which is closed with a plug 110, with a first portion of the second or coarse ceramic particles 124a to form a base layer, as described in block 624 of FIG. 6 and as represented in the cross section of FIG. 7A. The method 600 proceeds by determining if the positive passage mold 130 is to be surrounded with the first or fine ceramic particles 120 via layering in accordance with forming the fluidic module of FIG. 4 or via coating in accordance with forming the fluidic module of FIG. 5 (block 628).

If the positive passage mold 130 is to be surrounded with the first ceramic particles 120 via layering to form the fluidic module of FIG. 4, the method 600 includes covering the base layer comprising the first portion of the second ceramic particles 124a with a first portion of the first ceramic particles 120a to form a first layer (block 632, FIG. 7B). Next, the method 600 includes positioning the positive passage mold 130 on the first layer comprising the first portion of the first ceramic particles 120a (block 636, FIGS. 7B and 7C). Once the positive passage mold 130 is positioned on the first layer, the method 600 includes covering the first portion of the first ceramic particles 120a and the positive passage mold 130 with a second portion of the first ceramic particles 120b to form a second layer (block 640, FIG. 7D). Next, the method 600 includes covering the first and second portions of the first ceramic particles 120a, 120b and the positive passage mold 130 surrounded therein with a second portion of the second ceramic particles 124b to form a cover layer (block 644, FIG. 7E).

In embodiments, surrounding the positive passage mold with the first ceramic particles comprises forming the first layer with the first portion of the first ceramic particles 120a, positioning the positive passage mold 130 on the first layer, and forming the second layer on the first layer by covering the first portion of the first ceramic particles 120a and the positive passage mold 130 with the second portion of the first ceramic particles 120b. In embodiments, positioning the first ceramic particles and the positive passage mold between the second ceramic particles comprises forming the base layer with the first portion of the second ceramic particles 124a, positioning the first and second layers of the first ceramic particles 120a, 120b with the positive passage mold 130 surrounded therein on the base layer, and forming the cover layer on the second layer by covering the first ceramic particles and the positive passage mold surrounded therein with the second portion of the second ceramic particles 124b.

The respective layers of the first ceramic particles and the second ceramic particles can have different thicknesses relative to a total thickness of the loose ceramic powder in the press enclosure 100 before pressing as shown in FIG. 7E. In embodiments, the base layer comprising the first portion of the second ceramic particles 124a can have a thickness from about 15% to about 30% of the total thickness of the first and second ceramic particles before pressing. In embodiments, the first layer comprising the first portion of the first ceramic particles 120a can have a thickness from about 5% to about 20% of the total thickness of the first and second ceramic particles before pressing. In embodiments, the first layer comprising the first portion of the first ceramic particles 120a and the second layer comprising the second portion of the first ceramic particles 120b can have a combined thickness from about 40% to about 60% of the total thickness of the first and second ceramic particles before pressing. In embodiments, the cover layer comprising the second portion of the second ceramic particles 124b can have a thickness from about 15% to about 30% of the total thickness of the first and second ceramic particles before pressing.

In embodiments, the respective layers of the first ceramic particles and the second ceramic particles are made flat or otherwise leveled prior to addition of further layers and/or the positive passage mold 130. Any tool can be used to flatten or level the respective layers. Though the cross-sectional representations in the figures may show a solid line to delineate a boundary between different layers of the ceramic particles, it should be appreciated that the boundary in practice will appear rough at the granular scale where the ceramic particles in the different layers mix to some degree as they contact each other. The percent thicknesses of the respective layers of the first ceramic particles and the second ceramic particles relative to the total thickness of the loose ceramic powder in the press enclosure discussed above are determined in a direction generally parallel to the pressing force AF (FIG. 7F) after each layer is made flat. The thickness of each layer includes the shortest distance between the lowermost surface and the uppermost surface of the entire referenced layer.

In embodiments, the method 600 can include forming an intermediate layer comprising intermediate ceramic particles at an interface between the first ceramic particles and the second ceramic particles (not shown). The intermediate ceramic particles can have intermediate particle sizes defined by an intermediate PSD with an intermediate mean, an intermediate median, and an intermediate mode. In embodiments, at least one of (i) the intermediate mean is between the first mean and the second mean, (ii) the intermediate median is between the first median and the second median, and (iii) the intermediate mode is between the first mode and the second mode. In embodiments, a plurality of intermediate layers comprising intermediate ceramic particles can be formed at the interface between the first ceramic particles and the second ceramic particles. In embodiments, one or more intermediate layers are formed at all interfaces between the first ceramic particles and the second ceramic particles. In embodiments, the intermediate particle sizes of the intermediate ceramic particles increase in size in a direction through the one or more intermediate layers from the first particle sizes at the first ceramic particles to the second particle sizes at the second ceramic particles. The increase in size of the intermediate ceramic particles can be gradual, discrete, or a combination of thereof.

In embodiments of the method for forming the fluidic module of FIG. 4 with or without the one or more intermediate layers, the method 600 includes pressing the first ceramic particles 120a, 120b, the second ceramic particles 124a, 124b, and the positive passage mold 130 to form a pressed body (block 646, FIG. 7F). To perform the pressing, a piston or ram 140 is inserted in the press enclosure 100 and a uniaxial force AF is applied from above to compress the first ceramic particles and the second ceramic particles with the positive passage mold 130 inside to form the pressed body (FIG. 7F). The force AF applied by the ram 140 is configured to generate a pressure of approximately 30-40 MPa on the layers of ceramic particles and the positive passage mold 130. The pressure can vary in embodiments depending on the material and particle sizes of the ceramic particles and the material of the positive passage mold. For example, the force AF can be configured to generate at least 28 MPa, at least 25 MPa, or even at least 20 MPa on the contents of the press enclosure 100. The force can also be configured to generate at most 42 MPa, at most 45 MPa, at most 50 MPa, at most 70 MPa, at most 80 MPa, or even at most 100 MPa on the contents of the press enclosure 100. A reaction force or equal counteracting force AF (not shown) is supplied at the plug 110 during the pressing.

After pressing (block 646), the pressed body 150 is ejected from the press enclosure 100 to provide a green pressed fluidic module (FIG. 7G). In embodiments, the pressed body 150 can be removed by a (smaller) force AF (not shown) applied to the piston 140 and with the plug 110 configured to move out of the press enclosure 100. The first ceramic particles, the second ceramic particles, and the positive passage mold 130 are compressed by approximately 30-60% during pressing. The positive passage mold 130 is surrounded by the first and second layers of the first ceramic particles, which have joined together during the pressing to form a green first region 222g or inner layer of the green fluidic module. The base layer and cover layer of the second ceramic particles form a green second region 226g or outer layers of the green fluidic module. The first ceramic particles, the second ceramic particles, and any intermediate ceramic particles are joined together during pressing, resulting in interfaces that are free of voids. After pressing, one or more holes can be drilled into the major surfaces or sidewall/edge surfaces of the green fluidic module to serve as fluidic interfaces.

If the positive passage mold 130 is to be surrounded with the first ceramic particles 120 via coating to form the fluidic module of FIG. 5, the method 600 comprises applying the first ceramic particles to a surface of the positive passage mold 130 to form a surface coating 128 thereon (block 648). The first ceramic particles can be applied to the surface of the positive passage mold via one or more approaches that can be performed individually or in combination with one another. In one approach, the first ceramic particles are applied via a washcoating process that comprises dipping the positive passage mold in a ceramic slurry or slip with the first ceramic particles dispersed therein. In another approach, the first ceramic particles are applied via a spray process that comprises spraying droplets that include the first ceramic particles dispersed in a solvent suspension. In yet another approach, the first ceramic particles are applied via a flocking process. The flocking process in embodiments includes wetting the surface of positive passage mold with a material that serves as an adhesive and then exposing the wetted surface to ceramic powder that includes or consists of the first ceramic particles. In embodiments, electrostatic forces can assist the flocking process. An overmolding process can also be used to apply the ceramic powder with a liquid binder over the surface of the positive passage mold 130, where a portion of the liquid binder evaporates and/or cures to leave a layer of bound ceramic powder.

In embodiments, the first ceramic particles can be applied in a single application such that surface coating 128 has a single layer that comprises the first ceramic particles. In embodiments, the first ceramic particles can be applied in multiple discrete applications such that the surface coating 128 has a plurality of successive layers that comprise the first ceramic particles. The single layer and/or the successive layers in embodiments can have a total thickness of at least from about 50 μm to about 500 μm. In embodiments, the surface coating 128 has a thickness configured to prevent the larger second particle sizes of the second ceramic particles, which are separated from the surface of the positive passage mold 130, from penetrating through the single layer and/or the successive layers comprising the first ceramic particles. In embodiments, the total thickness of the single layer and/or successive layers is at most from about 10% to about 15% of the total thickness of all the powder placed in the press enclosure.

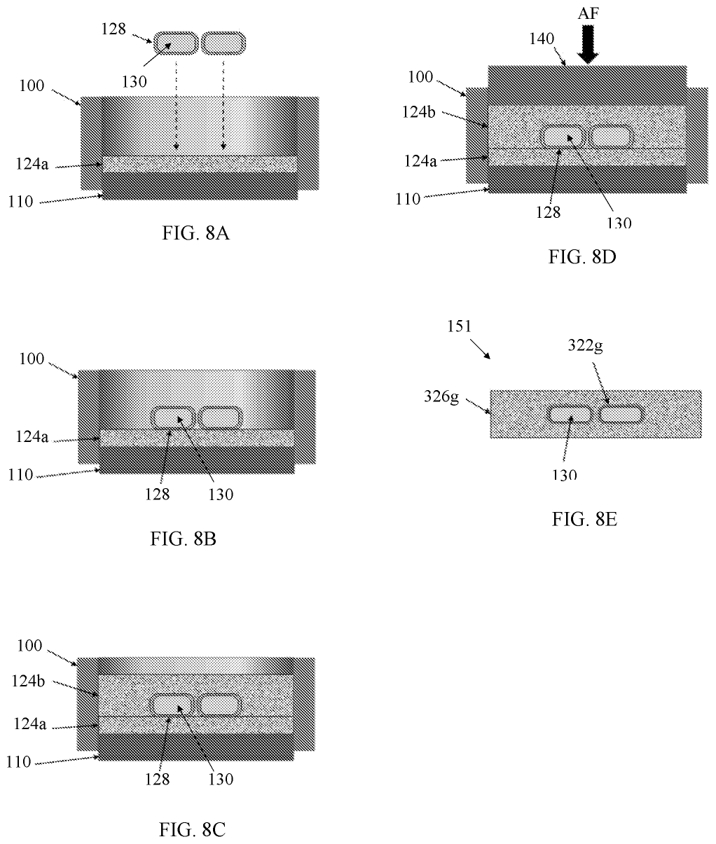

Once the first ceramic particles are applied to the surface of the positive passage mold 130 to form the surface coating 128 (block 648), the method 600 further includes positioning the coated positive passage mold 130 on the base layer comprising the first portion of the second ceramic particles 124a (block 652, FIGS. 8A and 8B). In embodiments, the thickness of the base layer is configured to ensure that the positive passage mold 130 is positioned properly in the vertical direction within the press enclosure 100. Next, the method 600 includes covering the first portion of the second ceramic particles 124a and the positive passage mold 130 comprising the surface coating 128 with a second portion of the second ceramic particles 124b to form a cover layer (block 656, FIG. 8C).

In embodiments, the surface coating 128 comprising the first ceramic particles can include one or more layers of intermediate ceramic particles applied between the first ceramic particles and the second ceramic particles. The intermediate ceramic particles can have the features described above with respect to aspects of the method 600 for forming the fluidic module of FIG. 4 and/or the intermediate ceramic particles can have additional or alternative features. In embodiments in which the surface coating 128 includes the one or more layers of intermediate particles, the method 600 can further comprise modifying an attribute of a material of each successive layer of the intermediate ceramic particles to form a graded or stepped interface between the first ceramic particles and the second ceramic particles.

The attribute of the material can include intermediate particle sizes of the intermediate ceramic particles with the intermediate particle sizes increasing with each successive layer. For example, the intermediate particle sizes of the intermediate particles can increase from smaller diameter particles that are similar to the first particle sizes of the first ceramic particles proximate to the surface of the positive passage mold 130 to larger diameter particles moving away from the positive passage mold 130. The attribute of the material can also include at least one component of one or more of the slurry or slip associated with the washcoating process, the solvent associated with the spraying process, the adhesive associated with the flocking process, and the binder of the intermediate ceramic particles associated with the one or more successive layers.

In embodiments, the respective layers of the second ceramic particles are made flat or otherwise leveled prior to addition of further layers and/or the positive passage mold 130. Any tool can be used to flatten or level the respective layers. Though the cross-sectional representations in the figures may show a solid line to delineate boundaries between the different layers of the ceramic particles, it should be appreciated that the boundary in practice will appear rough at the granular scale where the ceramic particles in the different layers mix to some degree as they contact each other.

In embodiments of the method for forming the fluidic module of FIG. 5 with or without the one or more intermediate layers, the method 600 includes pressing the second ceramic particles 124a. 124b and the positive passage mold 130 with the surface coating 128 comprising the first ceramic particles surrounded therein to form a pressed body (block 660, FIG. 8D). To perform the pressing, a piston or ram 140 is inserted in the press enclosure 100 and a uniaxial force AF is applied from above to compress the second ceramic particles with the coated positive passage mold 130 inside to form the pressed body 151. The force AF applied by the ram 140 is configured to generate a pressure of approximately 30-40 MPa on the ceramic particles and the coated positive passage mold 130. The pressure can vary in embodiments, sometimes in a direction towards higher pressures, depending on the material and particle sizes of the ceramic particles and the material of the positive passage mold as described with reference to FIG. 7F. A reaction force or equal counteracting force AF (not shown) is supplied at the plug 110 during the pressing.

After pressing (block 660), the pressed body 151 is ejected from the press enclosure 100 to provide a green pressed fluidic module (FIG. 8E). In embodiments, the pressed body 151 can be removed by a (smaller) force AF (not shown) applied to the piston 140 and with the plug 110 configured to move. The positive passage mold 130, the surface coating 128 comprising the first ceramic particles, and the second ceramic particles are compressed by approximately 30-60% during pressing. The surface coating 128 that surrounds the positive passage mold 130 includes the single layer and/or successive layers of the first ceramic particles, which have joined together during the pressing to form a green first region 322g or one or more contoured regions of the green fluidic module. The first and second portions of the second ceramic particles 124a, 124b corresponding to the base layer and cover layer, respectively, have joined together during the pressing to form a green second region 326g or bulk of the green fluidic module. The first ceramic particles, the second ceramic particles, and any intermediate ceramic particles are joined together during pressing, resulting in interfaces that are free of voids.

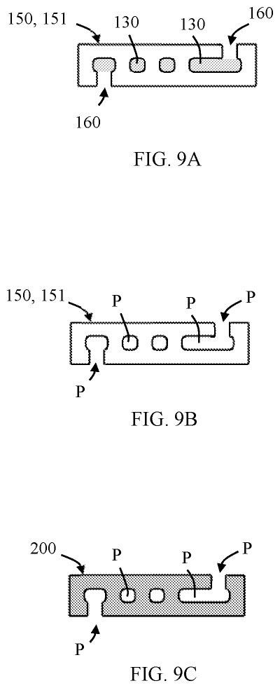

Common aspects of the method 600 of FIG. 6 for forming the ceramic fluidic module of FIG. 4 and the ceramic fluidic module of FIG. 5 are now described with reference to FIGS. 9A-9C. In embodiments, the pressed body 150, 151, now free from the press enclosure 100, can be machined in selected locations, such as by drilling, to form holes or fluidic ports 160 extending from the outside of the pressed body 150 to the positive passage mold 130 (FIG. 9A). In embodiments, the holes can additionally or alternatively be formed using a mold which includes the shape of the holes or fluidic ports as part of the mold. In embodiments, drilling can be delayed and used as part of a demolding step such as described below.

Next, the method 600 includes removing the positive passage mold 130 by heating the pressed body 150, 151, preferably at a relatively high rate, such that the positive passage mold 130 is melted and removed from the pressed body 150, 151 by flowing out of the pressed body 150, 151 (block 664, FIG. 9B). In embodiments, removing the positive passage mold 130 (block 664) can be divided into two parts, where first the pressed body 150, 151 is heated, and then next, separately, the material of the positive passage mold can flow out of the pressed body. In embodiments, removing the positive passage mold (664) can include heating the pressed body 150, 151 to melt positive passage mold 130, and only then drilling holes or fluidic ports, while the pressed body is still hot, allowing the mold material to flow out and complete demolding in this manner. The heating can be under partial vacuum, if desired. The heating can optionally include the additional application of uniaxial pressure on the major surfaces, or isostatic pressure (e.g., 20-80 bar) on all surfaces to prevent expansion of the mold material from cracking the green pressed body during melting.

Finally, the method 600 includes debinding the pressed body 150, 151 to remove any binder in the ceramic particles and then firing (sintering) the pressed body 150, 151 to densify and further solidify the pressed body into a monolithic ceramic body 200 comprising the first region 222, 322 and the second region 226, 326 (block 668, FIGS. 4, 5, and 9C).

The ceramic fluidic modules and module forming methods disclosed herein include tortuous fluid passages with interior surfaces that have reduced surface roughness compared to existing ceramic fluidic modules. The surface roughness of the fluid passage interior surfaces can depend on several factors related to the materials and the processes used to form the ceramic fluid modules.

The hardness of the mold material that forms the positive passage mold can effect the surface roughness of fluid passages in fluidic modules formed from pressed ceramic powder. During the pressing process, the individual granules or particles of the ceramic powder are compacted around the positive passage mold. The pressure of the pressing process can cause the ceramic powder granules to impact and/or indent the surface of the positive passage mold. Greater impaction/indentation of the positive passage mold may cause rougher fluid passage interior surfaces whereas lesser impaction/indentation may enable smoother fluid passage interior surfaces. If the positive passage mold is made from a softer material, such as a soft wax with Shore D durometer of 20-30, the ceramic granules can cause substantial indentation of the surface of the positive passage mold. If the positive passage mold is made from a harder material, such as a hard wax with a Shore D durometer of 40-50, the ceramic granules are unable to indent the surface of the positive passage mold, which can result in the production of smoother fluid passage interior surfaces. However, the use of harder materials may still present various processing challenges. To account for these processing challenges, the positive passage mold used in the method disclosed herein is formed from a mold material with a hardness configured to resist indentation from the ceramic particles, particularly the first or fine ceramic particles, during pressing. In embodiments, the hardness of the mold material of the positive passage mold is in a range of from about 20 to about 50 Shore D durometer, or even a range from about 30 to about 40 Shore D durometer.

The mold material can be an organic material such as an organic thermoplastic. The mold material can include organic or inorganic particles suspended or otherwise distributed within the material as a way of decreasing expansion during heating/melting. In embodiments, mold material is desirably a relatively incompressible material-specifically a material with low rebound after compression relative to the rebound of the pressed ceramic or SiC powder after compression. Mold materials loaded with particles can exhibit lower rebound after compression. Mold materials which are capable of some degree of non-elastic deformation under compression also naturally tend to have low rebound (e.g., materials with high loss modulus). Polymer substances with little or no cross-linking, for example, and/or materials with some local hardness or brittleness which enables localized fracturing or micro-fracturing upon compression can exhibit low rebound. Useful mold materials can include waxes with suspended particles such as carbon and/or inorganic particles, rosin containing waxes, high modulus brittle thermoplastics, organic solids suspended in organic fats such as cocoa powder in cocoa butter, and combinations thereof. Low melting point metal alloys also can be useful as mold materials, particularly alloys having low or no expansion on melting.

The size of the granules or particles of the ceramic powder can effect the surface roughness of fluid passage interior surfaces in fluidic modules formed from pressed ceramic powder. For the same positive passage mold hardness (hard or soft), large ceramic granules generally penetrate further into the surfaces of the positive passage mold during pressing as compared to small ceramic granules. In some cases, the depth of penetration of the ceramic particles is directly related to the diameter of the ceramic granules. In view of this correlation, reducing the size of the ceramic granules is one mechanism for reducing the surface roughness of fluid passage interior surfaces in fluidic modules formed from pressed ceramic powder. In some of the examples disclosed herein, it has been shown that fluid passages with smoother interior surfaces can be produced using ceramic powders comprising fine granules versus coarse granules.

The pressing pressure can effect the surface roughness of fluid passage interior surfaces in fluidic modules formed from pressed ceramic powder. A minimum pressing pressure may be used to achieve leak-free, high density ceramic material after sintering. Pressing using higher pressing pressures can increase ceramic material density, but it also tends to further increase the indentation of ceramic granules into the surface of the positive passage mold. Thus, internal channel sidewall surface roughness is expected to increase with higher pressing pressures. In view of these correlations, it is generally preferable to press the ceramic powder at the lowest possible pressing pressure to achieve the smoothest fluid passage interior surfaces.

### EXAMPLES

The following examples include the results of experiments performed to evaluate the use of fine ceramic powders derived from the different approaches discussed herein to form fluid passages with smooth interior surfaces. Some of different approaches described above for fabricating fine SiC powder were evaluated, including sieving RTP SiC powder to harvest smaller SiC granules and milling processes to reduce the PSD of RTP SiC powder. Additionally, samples formed using the layering approach (described with reference to FIG. 4) and the coating approach (described with reference to FIG. 5) for forming the ceramic modules were evaluated for surface roughness of fluid passage interior surfaces. Although the following examples may refer to specific mold materials for the molds used to form the channels in the test samples, such reference should not be interpreted as limiting the scope of this disclosure to those specific mold materials. For instance, it should be appreciated that useful mold materials can include different types of waxes (e.g., red wax, stacking wax, beeswax, bay wax, holding wax, rosin containing waxes, and cacao chocolate) or different versions/formulations of the same type of wax (e.g., stacking waxes #4, #5, #6, and #444 from Universal Photonics).

### Example 1

Test samples were fabricated by embedding a wax bar in fine SiC powder, followed by pressing, dewaxing, and debinding the samples. The debound samples were sectioned to expose channel sidewalls and then fired. After firing, the surface roughness of the channel was measured. The wax bars were fabricated by casting #444 Stacking wax (Universal Photonics (Central Islip, NY. USA)) into a generally rectangular cuboid shape. The wax bars were sized to fit into a pressing die measuring approximately 2.25″ in diameter. The pressing process involved placing the wax bar on a level layer of SiC powder, covering the wax bar with another layer of the same SiC powder, and pressing the contents into a pressed body. The die included a ram that was pressed to a maximum force of 11 tons (corresponding to 37 MPa on the contents of the die) with a one-minute hold. The test sample was ejected from the die by pushing the ram through the die.

After pressing, the test samples with the wax bars inside were subjected to the same rapid heating, debinding, sectioning, and firing to ensure the only variation in the experiment was the mechanism in which the ceramic powder was obtained or made. The samples were then subjected to an hour hold at 150° C. to melt out the wax. After the rapid heating, the samples were debound at 600° C. in a nitrogen atmosphere for 2 hours in a pyrolyzer. After debinding, the samples were sectioned to expose the internal channel surface. The sectioned parts were marked “a” and “b” to keep track of which channel surface was on top (“a”) and which was on the bottom (“b”) during pressing.

The top and bottom channel surfaces were measured for surface roughness using a Keyence VHS-5000 digital microscope. The surface roughness measurement is accurate to approximately 1 μm since it is based on an optical technique where focus and defocus of the image is observed in multiple z-stack images taken at different sample distances from the microscope objective. The surface roughness profile is created over a 2D profile, but the surface roughness can be measured along any user-defined path across the 2D profile. The debound sectioned parts were sintered in a Centorr Vacuum Industries graphite vacuum furnace under argon at maximum 2100° C. for four hours. The top and the bottom channel surfaces were measured again for surface roughness using the VHS-5000 digital microscope for comparison.

### Smooth Channel Sidewalls Using Sieved RTP SiC Powder

A commercial RTP SiC powder (Superior Graphite 2500NDP) was sieved to provide uniform distributions of fine and coarse RTP SiC powder. A single sieve can be used to separate the commercial RTP SiC powder into two powder groups: fine SiC powder that falls through the mesh (known as the “minus” product) and coarse SiC powder that is retained in the mesh (known as the “plus” product). In these experiments, three different sieves were used to create six different powder compositions. The three sieves used were: (1) #80 mesh, in which the −80 mesh product had granules <180 μm diameter and the +80 mesh product had granules ≥180 μm diameter; (2) #100 mesh, in which the −100 mesh product had granules <150 μm diameter and the +100 mesh product had granules ≥150 μm diameter; and (3) #120 mesh, in which the −120 mesh product had granules <125 μm diameter and the +120 mesh product had granules ≥125 um diameter.

Three 100 g batches of the commercial ceramic powder were passed through the three sieves described above. Each sieve was vibrated on a vibration table (at 50% setting) for fifteen minutes to accelerate powder flow through the mesh. The SiC powder that remained on the sieve and the powder that passed through the sieve was collected and weighed. The corresponding weight percentages for each mesh are as follows: (1) #80 mesh, the −80 mesh product was 60 wt % and the +80 mesh product was 40 wt %; (2) #100 mesh, −100 mesh product was 30 wt % and the +100 mesh product was 70 wt %; and (3) #120 mesh, the −120 mesh product was 20 wt % and the +120 mesh product was 80 wt %. As expected, as the mesh number increases (corresponding to smaller mesh openings and smaller granules passing through the mesh), the weight percentage of the minus compositions decreases.

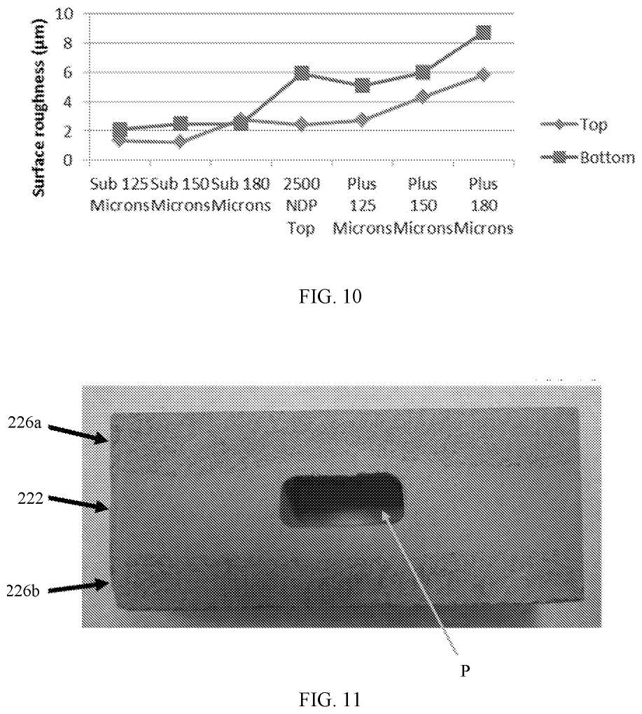

Test samples with the wax bars were pressed, dewaxed, debound, sectioned, and fired using the six sieved powder compositions described above and using the commercial SiC powder as a control. Channel surface roughness Ra measurements are reported in the graph shown in FIG. 10. The text along the x axis in graph corresponds to the plus or minus (“sub”) mesh product and the size of the that mesh product. For example, the text “Sub 125 Microns” in FIG. 10 refers to the surface roughness of channels formed from the −120 mesh product comprising granules that are less than 125 μm in diameter. The results reported in FIG. 10 indicate a good correlation between the reduction of large granules in the SiC powder and the reduction of channel surface roughness Ra. For example, using the fine particles from the −120 mesh product (<125 μm granule diameter), the channel top surface roughness was reduced from approximately 2.7 μm (based on measurements of the surface roughness of channels formed from the commercial RTP SiC powder without modification from Table 1) down to 1.85 μm fora reduction of 34%. Similarly, using the fine particles from the −120 mesh product, the channel bottom surface roughness was reduced from approximately 4-6 μm (based on measurements of the surface roughness of channels formed from the commercial RTP SiC powder without modification from Table 1) down to approximately 2 μm for a reduction of 50-66%.

### Smooth Channel Sidewalls Using Turbulent Mixing and Milling of RTP SiC Powder

Samples were prepared to evaluate channel sidewall smoothing using fine SiC powder formed by milling processes. Sample 1 included fine SiC particles formed by turbulent mixing of an 85/15 powder mixture (85 wt % Superior Graphite 2500NDP RTP SiC powder mixed with 15 wt % Superior Graphite 2500N SiC powder), mixed three hours with mixing media. Sample 3 included fine SiC particles formed by ball milling Superior Graphite 2500NDP RTP SiC powder for 28 hours followed by turbulent mixing with media for 2 hours. Two additional samples were prepared as control samples. Sample 2A and Sample 2B each included the Superior Graphite 2500NDP with no ball milling or mixing. The four samples were pressed, dewaxed, debound, sectioned, and fired. The samples were sectioned to expose the top channel surface and the bottom channel surface.

Measurements of channel roughness and density are provided in Table 1 below. Sample 1 had a high top channel surface roughness (16.6 μm) and a bottom channel surface roughness that is comparable to the bottom surface roughness on control Sample 2A. It is unclear why the top surface was so rough, though it is possible that the material of Sample 1 lacked very fine granules. Furthermore, it may be that the mixing process causes small particles to either fuse together or to fuse with larger granules. The absence of fine particles could explain why the channel top surface is rougher when SiC particles settle on the top surface of the wax channel form.

TABLE 1

| | | | | | | | Specific |
|---|---|---|---|---|---|---|---|
| Sample | Surface | Ra | Rq | Rt | Rp | Rv | Density |
| ID | Location | (μm) | (μm) | (μm) | (μm) | (μm) | (g/cc) |
| Sample 1 | Top | 16.61 | 20.90 | 109.03 | 28.89 | 80.14 | 98.40% |
| | Bottom | 3.80 | 5.44 | 34.16 | 5.93 | 28.23 | |
| Sample 2A | Top | 2.86 | 3.85 | 26.51 | 10.10 | 16.41 | 98.70% |
| | Bottom | 3.62 | 4.42 | 20.77 | 7.32 | 13.45 | |
| Sample 2B | Top | 2.74 | 3.57 | 22.58 | 12.50 | 10.08 | 98.10% |
| | Bottom | 6.01 | 7.35 | 31.51 | 12.11 | 19.40 | |
| Sample 3 | Top | 2.07 | 2.56 | 12.13 | 3.49 | 8.64 | 98.80% |
| | Bottom | 1.93 | 2.35 | 13.04 | 5.43 | 7.60 | |

The surface roughness results in Ra for the top and bottom surfaces of Sample 3 were both approximately 2 μm. For the top surface, the surface roughness measurement value is a modest improvement over the surface roughness for control Samples 2A and 2B. The bottom surface roughness for Sample 3 provides a considerable improvement (50-66% reduction) over Control Samples 2A and 2B. Measurements of channel surface roughness on turbulent mixed and balled milled samples indicate that ball milled SiC powders provide an advantage over control samples with Ra values of approximately 2 μm for both top and bottom channel surfaces. The experiment showed that techniques for reducing the size of SiC granules can reduce channel surface roughness.

### Example 2

A sample was fabricated to evaluate the layered sieved SiC powder approach (described with reference to FIG. 4) for reducing channel sidewall roughness. The layered sample was assembled in the following sequence: (1) a bottom layer of coarse powder: approximately 30 grams of +100 mesh SiC powder (>150 μm diameter); (2) a first layer of fine powder: approximately 15 grams of −100 mesh SiC powder (<150 μm); (3) a wax bar formed from #444 Stacking wax (Universal Photonics (Central Islip, NY, USA)); (4) a second layer of fine powder: approximately 25 grams of −100 mesh SiC powder (<150 μm); and (5) a cover layer of coarse powder: approximately 30 grams of +100 mesh SiC powder (>150 μm).

The sample was then pressed (using the same pressing die in Example 1), dewaxed, and debound. After debinding the sample was sawed into five pieces to enable channel top and bottom surface roughness measurements. FIG. 11 shows the cross-section of the sample after debinding. As shown, the channel P is surrounded by fine SiC powder in a central layer 222, and coarse SiC powder layers 226a, 226b are arranged above and below the fine SiC powder layer. There were no visible cracks along either interface of the course and fine layers of powder after debinding.

The sample pieces were then fired. No cracks or separation of fine and coarse layers were observed after firing. Measurements of channel top and bottom surface roughness are provided in the first line for Sample 2-1 in Table 2 below. Based on measurements of the surface roughness of channels formed from the commercial RTP SiC powder without modification from Table 1, the channel top surface roughness was reduced from approximately 2.7 μm down to 1.43 μm (a reduction of 47%) and the channel bottom surface roughness was reduced from 4-6 μm down to approximately 1.97 μm (a reduction of 51-67%).

TABLE 2

| | | Top Ra | Bottom | Top Rt | Bottom |
|---|---|---|---|---|---|
| Sample ID | Description | (μm) | Ra (μm) | (μm) | Rt (μm) |
| Sample 2-1 | Layered-100 Mesh | 1.43 | 1.97 | 10.32 | 14.06 |
| | SiC Powder | | | | |
| Sample 2-2 | Pure-100 Mesh SiC | 1.25 | 2.19 | 10.09 | 17.61 |
| | Powder | | | | |

For comparison, the measured channel surface roughness of a separate non-layered sample fabricated entirely from similar fine SiC powder (−100 mesh, with granule diameters <150 μm) is shown in the second line for Sample 2-2 in Table 2. The measured channel top and bottom surface roughnesses for Sample 2-2 are very similar to the surface roughnesses observed using layers of sieved SiC powder as demonstrated with Sample 2-1.

The porosity of the external surface of the layered sample was evaluated after firing. The +100 mesh exterior as fired surface passed leak testing, with a ΔP=−0.02 bar over 30 min (where ΔP<−0.05 bar is passing). The channel sidewall surfaces formed using fine SiC powder were also shown to be leak-free.

### Example 3

Experiments were carried out to evaluate the coating SiC powder approach (described with reference to FIG. 5) for reducing channel sidewall roughness. In particular, dip coating of fine SiC powder on the surface of passage molds was explored in experiments. An ethanol-based slip was developed with the following formulation: 80 wt % ethanol solvent, 4 wt % polymer binder, and 16 wt % raw SiC powder (Superior Graphite 2500N).

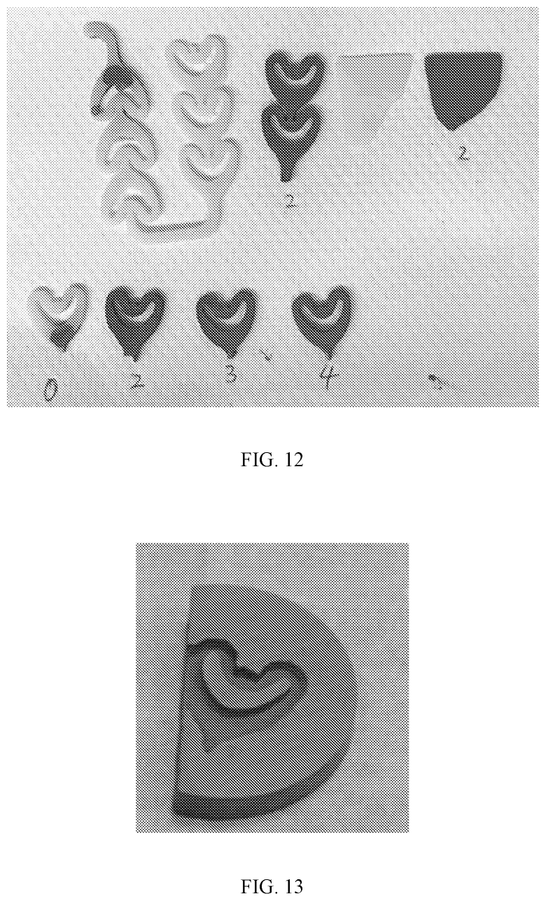

Several passage molds using #444 Stacking wax (Universal Photonics (Central Islip, NY, USA)) were prepared for dip coating experiments. The passage molds included different geometries, such as mixers and sheets (FIG. 12). The passage molds were dipped in the SiC slip and then allowed to dry in air at room temperature. A minimum of two dip coating cycles were used to cover the passage molds. In general, four dip coatings were used to provide a thicker coating. In FIG. 12, the number of dip coating cycles is written below each passage mold sample. A potential advantage of the coating SiC powder approach is that if the coating is applied in a sufficiently thick layer it can help stabilize thin passage molds that might otherwise break during handling and/or insertion into the pressing die.

The dip-coated passage molds were pressed into approximately 1.5″ diameter disks using a commercial RTP SiC powder (Superior Graphite 2500NDP RTP SiC Powder). A first or base layer of SiC powder was formed on the bottom of a pressing die. Then, the dip-coated passage mold was placed on top of the SiC powder base layer. The dip-coated passage mold was then covered with a second layer of SiC powder and the disk was pressed with enough force to generate a pressure of at least approximately 40 MPa. After pressing, the disk samples were debound and then sectioned in half to expose the top and bottom surfaces of the internal channel (FIG. 13). These samples demonstrated that a smooth channel surface layer could be formed using the dip coating approach.

Additional samples were prepared by dip coating wax bars in the SiC slurry. The wax bars were sized to fit into a pressing die measuring approximately 2.25″ in diameter. The pressing die was used to press these samples into disks using the commercial RTP SiC powder. The wax bars used in these samples were only partially dipped in the SiC slurry so that each sample includes a coated region and uncoated region. This partial coverage enabled direct comparison of the dip coating process with uncoated surfaces for visual inspection and surface roughness measurements. The samples were then debound and fired.

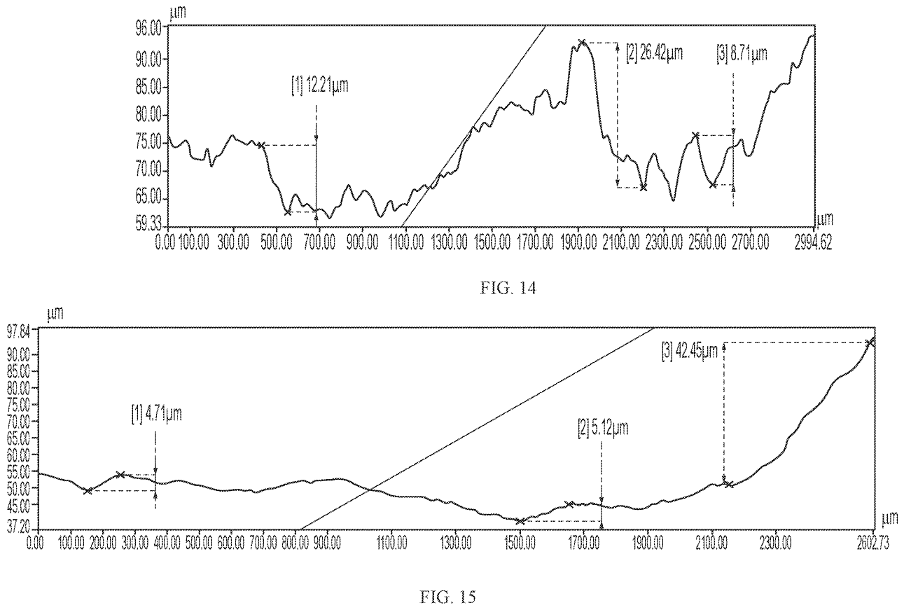

FIGS. 14 and 15 show measurements of the surface profile for the uncoated region (FIG. 14) and the coated region (FIG. 15) for one of the samples. Note that the two surface profile plots are not shown at the same vertical scale, but vertical divisions are provided every 5 μm. Comparing the two profiles, the dip coated surface is significantly smoother than the uncoated surface. The two plots are taken over similar lengths along the surface (approximately 3.0 mm for the uncoated surface plot and approximately 2.6 mm for the for the dip-coated surface plot).

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected. Indeed, while flow reactor performance is one application that can benefit from using smoother channel surfaces, there are other applications in which increasing surface roughness from using course particle could be preferable. For example, rough surfaces can be used to reduce heat transfer by forming a thin fluidic insulating layer near a boundary surface, and rough surfaces can also be used to locally enhance heat transfer via nucleate boiling (where the objective is to extract heat from the substrate in a heat exchange channel). The proposed approach allows free adjustment of the channel surface roughness along the channel path to optimize performance.

1. A method of forming a ceramic fluidic module for a flow reactor, comprising:
surrounding a positive passage mold with first ceramic particles, the positive passage mold defining a passage having a tortuous shape, the first ceramic particles having first particle sizes defined by a first particle size distribution (PSD) with a first mean, a first median, and a first mode;
positioning the first ceramic particles and the positive passage mold between second ceramic particles, the second ceramic particles having second particle sizes defined by a second PSD with a second mean, a second median, and a second mode, wherein at least one of (i) the first mean is less than the second mean, (ii) the first median is less than the second median, and (iii) the first mode is less than the second mode;
pressing the first ceramic particles, the second ceramic particles, and the positive passage mold to form a pressed body;
heating the pressed body to remove the positive passage mold; and
sintering the pressed body to form a high density, closed-porosity ceramic body having a tortuous fluid passage extending therethrough.

2. The method of claim 1, wherein surrounding the positive passage mold with the first ceramic particles comprises:
forming a first layer with a first portion of the first ceramic particles,
positioning the positive passage mold on the first layer, and
forming a second layer on the first layer by covering the first portion of the first ceramic particles and the positive passage mold with a second portion of the first ceramic particles.

3. The method of claim 2, wherein positioning the first ceramic particles and the positive passage mold between the second ceramic particles comprises:
forming a base layer with a first portion of the second ceramic particles, the first layer of the first ceramic particles formed on the base layer, and
forming a cover layer on the second layer by covering the first ceramic particles and the positive passage mold surrounded therein with a second portion of the second ceramic particles.

4-7. (canceled)

8. The method of claim 1, wherein surrounding the positive passage mold with the first ceramic particles comprises applying the first ceramic particles to a surface of the positive passage mold to form a surface coating thereon.

9. The method of claim 8, wherein applying the first ceramic particles to the surface of the positive passage mold comprises one or more of washcoating, spraying, and flocking to form the surface coating.

10-38. (canceled)

39. A fluidic module, comprising:
a monolithic closed-porosity ceramic body having a first region and a second region with the first region disposed between the second region, the first and second regions differing with respect to a common attribute of a ceramic material of the ceramic body; and
a tortuous fluid passage extending through the ceramic body and surrounded by the first region such that the tortuous fluid passage is separated entirely from the second region, the tortuous fluid passage having an interior surface with a surface roughness of less than or equal to 5 μm Ra.

40. The fluidic module of claim 39, wherein the surface roughness is in a range of from 0.1 to 5 μm Ra.

41. (canceled)

42. The fluidic module of claim 39, wherein the ceramic material of the ceramic body has a density of at least 97% of a theoretical maximum density of ceramic material.

43. (canceled)

44. (canceled)

45. The fluidic module of claim 39, wherein the common attribute is density, the first region having a first density that is greater than a second density of the second region.

46. The fluidic module of claim 39, wherein the ceramic material of the ceramic body has a closed porosity of less than 3%.

47. (canceled)

48. (canceled)

49. The fluidic module of claim 39, wherein the common attribute is closed porosity, the first region having a first closed porosity that is less than a second closed porosity of the second region.

50. The fluidic module of claim 39, wherein the common material attribute is average grain size, the first region having a first average grain size that is less than a second average grain size of the second region.

51. The fluidic module of claim 39, wherein the second region comprises at least two outer layers and the first region comprises an inner layer disposed between the at least two outer layers.

52. The fluidic module of any one of claim 51, wherein the at least two outer layers and the inner layer are planar layers arranged between major surfaces of the fluidic module.

53. The fluidic module of claim 39, wherein the first region has a substantially uniform thickness extending substantially perpendicularly from the interior surface of the tortuous fluid passage.

54. The fluidic module of claim 53, wherein the thickness of the first region is in a range of from about 50 μm to about 500 μm.

55. The fluidic module of claim 39, wherein at least one interface between the first region and the second region comprises the ceramic material, and wherein the value of the common attribute of the at least one interface is between the value of the common attribute of the first region and the value of the common attribute of the second region.

56. The fluidic module of claim 55, wherein the at least one interface includes a plurality of interfaces and the value of the common attribute of each interface is between the value of the common attribute of the first region and the value of the common attribute of the second region.

57. The fluidic module of claim 55, wherein the common attribute of the at least one interface and/or all the interfaces transitions gradually between the common attribute of the first region and the common attribute of the second region.

58. The fluidic module of claim 39, wherein the interior surface of tortuous fluid passage comprises a floor and a ceiling separated by a height h and two opposing sidewalls joining the floor and the ceiling, the sidewalls separated by a width W measured perpendicular to the height h and at a position corresponding to one-half of the height h wherein the height h of the tortuous fluid passage is in the range of from 0.1 to 20 mm.
